(19) United States
(12) Patent Application Publication
(10) Pub. No.: US 2008/0132213 A1
(43) Pub. Date: Jun. 5, 2008

(54) Method and system for measuring and displaying current weather conditions within wireless cellular phones at the cellular phone's current location

(76) Inventors: Dan Rittman, Atlit (IL); Aliza Schnapp, Los Angeles, CA (US)

Correspondence Address: DANNY RITTMAN, P.O. Box 2040, Atlit, 30300, omitted

(21) Appl. No.: 11/607,621

(22) Filed: Dec. 4, 2006

(51) Int. Cl. H04Q 7/22

(52) U.S. Cl. 455/414.3

(57) ABSTRACT

A system and method for measuring and displaying current weather conditions on wireless cellular phones are shown. An electronic weather system collects current weather information data from sensors within wireless cellular phone using a collection program and assembles the data in the cellular phone's memory. An internal program is used to display the weather information on the wireless cellular phone display device such as Liquid Crystal Display (LCD) and others. A user can view the weather information such as temperature, humidity, wind speed and direction, rainfall, barometric pressure, dew point, windchill, altitude, compass, longitude, latitude, heat index, UV Index and moonlight and tides conditions for outdoor activities, at the cellular phone's current location which can be outdoors or indoors. The system shares the information with other wireless cellular phones via global web program over the internet.

### BACKGROUND OF INVENTION

1. Technical Field of the Invention

The present invention relates generally to the field of providing current weather conditions on wireless cellular phones. An electronic weather system collects current weather information data from sensors within wireless cellular phone using a collection program and assembles the data in the cellular phone's memory. An internal program is used to display the weather information on the wireless cellular phone display device such as Liquid Crystal Display (LCD) and others. A user can view the weather information such as temperature, humidity, wind speed and direction, rainfall, barometric pressure, dew point, windchill, altitude, compass, longitude, latitude, heat index, UV Index and moonlight and tides conditions for outdoor activities, at the cellular phone's current location which can be outdoors or indoors.

2. Background of the Invention

In recent years, wireless cellular telephones are used widely and spreading remarkably well around the world. During the past decade, a network function was added to wireless telephones, and many people now use the Internet through wireless telephones. The typical wireless cellular telephone has a liquid crystal display screen that displays information such as a caller's telephone number, incoming calls ID, time and date and other vital information regarding the communication system. In recent years many other features were added to wireless cellular phones like games, calculators, office tools, secured internet and email features and more. The cellular telephone technologies are advanced in Japan, for example, bigger display screen and able to display colored images. The current wireless telephone technologies only allow conversations and limited information exchange. Furthermore, it is not possible to transfer broader ranges of information to certain people, such as an emergency notification to an affected geographic area.

Our invention was created to add vital information to be included within wireless cellular phones; the current weather conditions at the phone's current location. Using built-in sensors the modern wireless cellular phone will be able to provide important weather conditions through the phone's display. The wireless cellular phone that is described in this invention includes sensors that can provide vital weather information up to 300 feet away. A user can view the weather information such as temperature, humidity, wind speed and direction, rainfall, barometric pressure, dew point, windchill, altitude, compass, longitude, latitude, heat index, UV Index and moonlight and tides conditions for outdoor activities, at the cellular phone's current location which can be outdoors or indoors.

### SUMMARY OF THE INVENTION

This and additional objects are accomplished by the present invention, wherein, briefly, current weather conditions can be measured and displayed on wireless cellular phone at the phone current location.

The system includes wireless cellular phone that is equipped with weather sensors to measure current weather conditions at the cellular phone's current location which can be indoors or outdoors. An electronic system which is embedded within the cellular phone system provides the weather information to an internal program that compiles the data and presents it on the phone display screen. The system provides the next weather details: temperature, humidity, wind speed and direction, rainfall, barometric pressure, dew point, windchill, altitude, compass, longitude, latitude, heat index, UV Index and moonlight and tides conditions for outdoor activities, at the cellular phone's current location which can be outdoors or indoors.

The weather information has become an important factor in people's daily life routine. It can provide essential weather information for travelers, hikers, bikers and any other types of outdoors athletes. The additional information provided by the cellular phone described in this invention like compass, altitude, longitude, latitude and barometric pressure can save lives for mountain climbers, sailors at sea and other types of outdoors activity seekers. The cellular phone described in this invention has the capability to share its current weather information with other similar phones through an integral internet program. In this way many users in different locations around the world can share their current weather conditions information.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates a block diagram of a system and method for measuring and displaying current weather conditions on wireless cellular phones.

### DESCRIPTION OF A PREFERRED EMBODIMENT

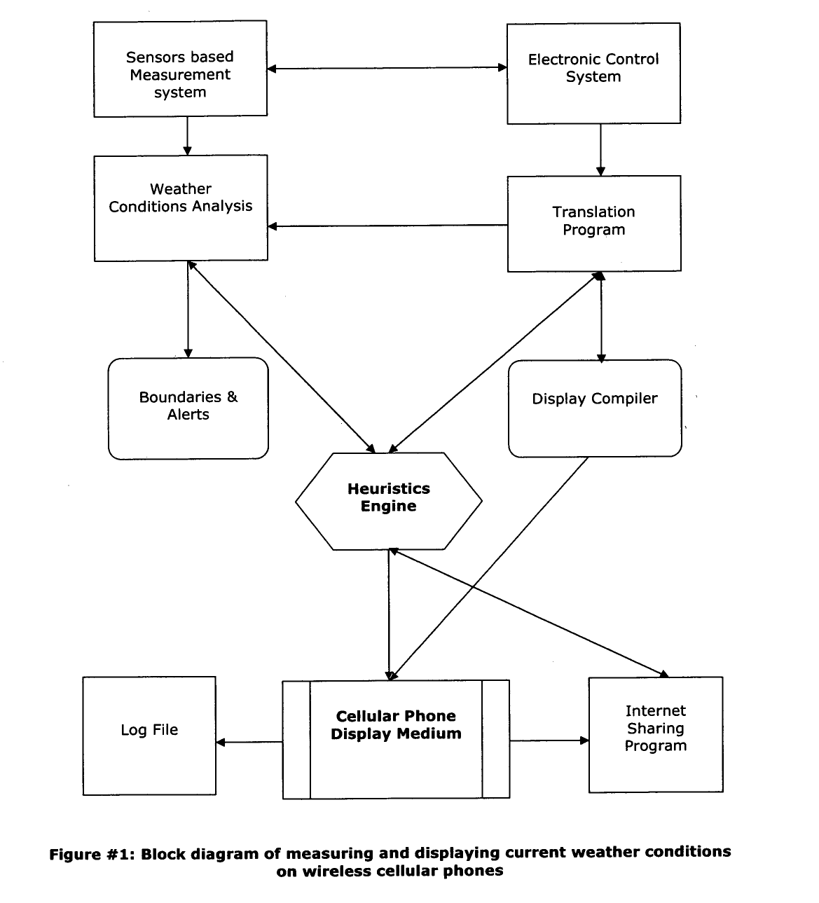

Referring to FIG. 1, conceptually illustrates is the functional block diagram of a system and method for measuring and displaying current weather conditions on wireless cellular phones

Sensors based Measurement system—The system consists of INPUT module for reading weather conditions. This system consists of advanced sensors for measuring wide variety of weather conditions.

Electronic Control System—The electronic control system is an embedded control logic circuitry that is working with the sensors. The system sends and receives information from the measuring weather sensors.

Weather Conditions Analysis—This module analyze the sensor's results.

Translation Program—Is responsible for sensor's and the electronic control system's results translation to digital type of information to be compiled later and display on the cellular phone display medium.

Display Compiler—This part is compiling the weather information into digital data for display purposes.

Boundaries & Alerts—This module is categorizing and analyzing all weather information for alerts and boundaries. For Example: This module is responsible to provide alerts about rising or falling temperature and humidity. Second example is 48-hour Bar Graph history of barometric pressure. Third example is alerting the user about rising level of UV radiation. Fourth example is altitude alert.

Heuristic Engine—The heuristic engine is the core of the entire system. It is responsible for the entire system functionality. It also works with the program that runs on the Internet to share current weather conditions with other users around the world.

Cellular Phone Display Medium—The cellular phone display medium device, made of Liquid Crystal Display (LCD), electroluminescent, Back Lighting type display or others.

Log File—Is a detailed log file that is produced upon the completion of a weather conditions and can be downloaded to a computer. The log files are also available via the web interface or optional email.

Internet Sharing Program—An advanced internet based program to share current cellular phone location weather conditions with all similar systems around the world via the internet. This program creates a world wide weather data taking information from each cellular phone's location. The system collects data from any cellular phone that includes the system that described in this invention and shares the information based on detailed longitude, latitude over the internet, at any given time.

### DETAILED DESCRIPTION OF THE INVENTION

This invention describes a new feature that is added into wireless cellular phone. The idea is to equip a wireless cellular phone with the capability of measuring and displaying current weather conditions at the cellular phone's current location. The cellular phone's includes built-in weather sensors to measure current weather conditions at the cellular phone's current location which can be indoors or outdoors. An electronic system which is a logic circuitry is embedded within the cellular phone system and provides the weather information to another internal program that compiles the data into digital information type to present it on the cellular phone's display medium. The cellular phone display medium may be made of any type. The most common types are liquid digital display (LCD), electroluminescent, Back Lighting type display or others. The system provides vital weather details that includes temperature, humidity, wind speed and direction, rainfall, barometric pressure, dew point, windchill, altitude, compass, longitude, latitude, heat index, UV Index and moonlight and tides conditions for outdoor activities, at the cellular phone's current location which can be outdoors or indoors. One of the key advantages of the system is its alerting capabilities. User may set alert for any changes in weather conditions. For example in case of altitude change or barometric pressure dangerous value. The system also provides 48 hours bar graph history of weather conditions. For example, barometric pressure changes, temperature and humidity. Important weather information that the system provides is moonlight and tides conditions and UV index. In addition the system includes a built-in dangerous weather conditions alerts to warn the user regarding fatal circumstances. All information is prepared by the display compiler program to be neatly presented on the cellular phone display medium. The system is fully supporting touch-screen display types in order to exhibit and set necessary functions. The cellular phone described in this invention has the capability to share its current weather information with other similar phones through an integral internet program. In this way many users in different locations around the world can share their current weather conditions information.

The processing instructions for measuring and displaying current weather conditions on wireless cellular phones internet sharing program may be encoded in computer-usable media. Such computer-usable media may include, without limitation, storage media such as floppy disks, hard disks, CD-ROMS, DVDs, read-only memory, and random access memory; as well as communications media such wires, optical fibers, microwaves, radio waves, and other electromagnetic or optical carriers.

1. A method and system for measuring and displaying current weather conditions on wireless cellular phones are shown, comprising: An electronic weather system collects current weather information data from sensors within wireless cellular phone using a collection program and assembles the data in the cellular phone's memory and; An internal program is used to compile and display the weather information on the wireless cellular phone display device and; A user can view the weather information such as temperature, humidity, wind speed, gust and direction, rainfall, barometric pressure, dew point, windchill, altitude, compass, longitude, latitude, UV Index, heat index and moonlight and tides conditions for outdoor activities at the cellular phone's current location which can be outdoors or indoors and; The system shares the information with other wireless cellular phones via global web program over the internet.

2. The method and system of claim 1, wherein the wireless cellular phone device can be any type of cellular means.

3. The method and system of claim 1, wherein the electronic weather system is embedded within the wireless cellular phone device.

4. The method and system of claim 1, wherein the sensors are electronic sensing devices that are an integral part of the wireless cellular phone device.

5. The method and system of claim 1, wherein the collection program is embedded within the wireless cellular phone memory and it is an integral part of it.

6. The method and system of claim 1, wherein an internal program is used to compile and display the current weather information on the wireless cellular phone display device.

7. The method and system of claim 1, wherein the cellular phone display device may be of different types such as liquid crystal display (LCD), electroluminescent, Back Lighting Display or others.

8. The method and system of claim 1, wherein the user can view the temperature at the wireless cellular phone's current location.

9. The method and system of claim 1, wherein the user can view the humidity conditions at the wireless cellular phone's current location.

10. The method and system of claim 1, wherein the user can view the wind speed, gust and direction at the wireless cellular phone's current location.

11. The method and system of claim 1, wherein the user can view the rainfall conditions at the wireless cellular phone's current location.

12. The method and system of claim 1, wherein the user can view the barometric pressure at the wireless cellular phone's current location. In addition the system shows 48-hour Bar Graph history of barometric pressure.

13. The method and system of claim 1, wherein the user can view the dew point at the wireless cellular phone's current location.

14. The method and system of claim 1, wherein the user can view the windchill factor at the wireless cellular phone's current location.

15. The method and system of claim 1, wherein the user can view a compass at the wireless cellular phone's current location.

16. The method and system of claim 1, wherein the user can view the longitude and latitude at the wireless cellular phone's current location using satellite connection and/or internet information.

17. The method and system of claim 1, wherein the user can view the heat index at the wireless cellular phone's current location.

18. The method and system of claim 1, wherein the user can view the UV Index at the wireless cellular phone's current location using integral UV sensors, embedded within the wireless cellular phone device.

19. The method and system of claim 1, wherein the system provides a moon phase icon to measure moonlight and tides conditions for outdoor activities, at the wireless cellular phone's current location.

20. The method and system of claim 1, wherein the system displays three levels of temperature and humidity trends: rising, steady, or falling, at the wireless cellular phone's current location.

21. The method and system of claim 1, wherein the system includes customizable weather alarms for all weather measurements.

22. The method and system of claim 1, wherein the system includes Altitude adjustment for barometric pressure values.

23. The method and system of claim 1, wherein the wireless cellular phone's current location may be outdoors or indoors.
